(19) United States
(12) Patent Application Publication
(10) Pub. No.: US 2013/0127653 A1
(43) Pub. Date: May 23, 2013

(54) METHOD AND APPARATUS FOR LENGTH MEASUREMENT ON AN ELECTRODE

(71) Applicants: Jorg Dienenthal, Wilnsdorf (DE); Hans-Uwe Morgenstern, Freudenberg (DE)

(72) Inventors: Jorg Dienenthal, Wilnsdorf (DE); Hans-Uwe Morgenstern, Freudenberg (DE)

(21) Appl. No.: 13/697,649

(22) PCT Filed: May 26, 2011
(86) PCT No.: PCT/EP2011/058678

§ 371 Date: Jan. 24, 2013

(30) Foreign Application Priority Data
Jun. 1, 2010 (EP) 10164644.6

(51) Int. Cl. G01S 13/08

(52) U.S. Cl. CPC G01S 13/08
USPC 342/118

(57) ABSTRACT

A device and an apparatus for measuring the length of an electrode (14) or determining the position of a consumable cross-section (17) of the electrode (14) in an electric furnace (10), in which the measuring is performed by radar in such a manner that a radar transmitter/receiver device (22) is connected by a waveguide connection device (21) to a waveguide (20), which is arranged on the electrode (14) and extends in the consumption direction (19) of the electrode (14) from an end cross-section (18) of the electrode (14) to a consumable cross-section (17) of the electrode (14), and the time difference is measured between the emission of the radar signal an the reception of an echo generated by reflection from a discontinuity point of the waveguide in the consumable cross-section (17) of the electrode (14).

The present invention relates to a method for measuring the length of an electrode or determining the position of a consumable cross-section of the electrode in an electric furnace, in which the measuring is performed by radar in such a manner that a radar transmitter/receiver device is connected by means of a waveguide connection device to a waveguide, which is formed as a waveguide tube or waveguide duct, is arranged on the electrode and extends in the consumption direction of the electrode from an end cross-section to a consumable cross-section of the electrode, and the time difference is measured between the emission of the radar signal and the reception of the echo generated by reflection from a discontinuity point of the waveguide in the consumable cross-section of the electrode. Further, the invention relates to an apparatus for implementing the method.

In so-called “electric furnaces”, metal is molten in a furnace vessel by means of thermal energy released by forming an electric arc between an electrode and the metal or the melt. In this process, the electrodes are continuously consumed so that, for adjusting a desired distance between the end of the electrode defined by a consumable cross-section and the metal to be molten or the melt, the electrode has to be fed against the consumption direction.

In order to achieve constant conditions during the entire melting process, it is important to keep said distance as constant and defined as possible, for which a feeding of the electrode should correspond, if possible, to the rate of consumption of the electrode. For this purpose it is necessary to ascertain the length of the electrode or the relative position of the consumable cross-section in relation to the melt surface. This is true independent of whether the consumable cross-section is arranged above the molten bath or dipped into the molten bath depending on the respective melting method.

For ascertaining the electrode length or the distance of the consumable cross-section of the electrode from the melt surface, different methods are known. For example, it is known from U.S. Pat. No. 4,843,234 to calculate the length of the electrode by means of an optical waveguide arrangement arranged on or in the electrode by determining the electrode length as a length difference. To achieve a satisfactory accuracy, it is advised in U.S. Pat. No. 4,843,234 to use two separate optical waveguide arrangements, which require an accordingly complex overall design of the measuring equipment. In addition, special measures are required in the known method to protect the optical waveguide from the extreme temperatures in the electric furnace.

EP 1 181 841 B1 shows a method in which the distance between the electrode tip and the melt surface is implemented by measuring the reference length on an electrode stroke system. Apart from the fact that the ascertainment of the position of the electrode tip or the consumable cross-section of the electrode above the melt surface is reached independently of the length of the electrode, a subsequent difference value calculation with regard to a correction value is necessary for calculating the distance, which correction value results from the electrode being consumed between two measurements. Thus, the method known from EP 1 181 841 B1 provides neither the measurement of the length of the electrode, nor the in situ ascertainment of the distance between the electrode tip and the melt surface.

Thus, it is the object of the present invention to provide a method and an apparatus which provide an in situ measurement of the electrode length and the ascertainment of the position of the consumable cross-section of the electrode with the smallest possible effort.

This object is attained by a method with the features of claim 1 and an apparatus with the features of claim 5.

In the method according to the invention, the measurement is performed by radar in such a manner that a radar transmitter/receiver device is connected by means of a waveguide connection device to a waveguide, which is arranged on the electrode and extends in a consumption direction of the electrode from an end cross-section of the electrode to a consumable cross-section of the electrode and which is formed as a waveguide tube or waveguide duct, and the time difference is measured between the emission of the radar signal and the reception of the echo which is generated by reflection from a discontinuity point of the waveguide in the consumable cross-section of the electrode.

The method according to the invention provides a permanent measurement during running operation of the electric furnace by means of a waveguide arranged on the electrode. Because, due to the electrode combustion, the end of the waveguide is continuously situated in the consumable cross-section or at the level of the consumable cross-section, as in the case of a waveguide running outside of the electrode mass, it is made sure that the end of the waveguide can be taken as an accurate reference value for the position of the consumable cross-section and, thus, the current length of the electrode can also be determined when the position of the upper end of the electrode is known.

As a waveguide, a waveguide tube running lengthwise to the electrode or a waveguide tube running within the electrode will be used. If a formation or arrangement of a waveguide within the electrode is intended, the waveguide can be formed by a duct formed within the electrode in the electrode material itself, said duct having a duct wall suitable for the propagation of radar waves. The end of the waveguide, which is disposed within or on the level of the consumable cross-section, forms a discontinuity point or inhomogeneity point which generates an according echo of the electromagnetic waves used as radar waves, which echo is detected in the receiver portion of the radar transmitter/receiver device.

In a particularly preferred variation of the method, the length of the waveguide connection device is changed in order to adjust the spatial distance between a radar transmitter/receiver device positioned independently of the electrode and the end cross-section of the electrode. In contrast to the case in which the radar transmitter/receiver device is positioned in close proximity to the end cross-section and, thus, the waveguide connection device can be formed as a connection unchangeable regarding its longitudinal extension, a realization of the waveguide connection device changeable in length allows for an optional relative positioning of the radar transmitter/receiver device in relation to the end cross-section of the electrode. Thus, it is also possible to arrange the radar transmitter/receiver device outside of the furnace chamber in a protected position, in particular with respect to the thermal stress, and to use the waveguide connection device for bridging the distance between the position of the radar transmitter/receiver device, which is for example rigidly defined in relation to a furnace wall, and the end cross-section of the electrode. In this respect, it is particularly advantageous if the waveguide connection device is formed from a tube which corresponds in its dimension and its material to the waveguide.

In particular in the case that, for melting the material in the electric furnace, a Söderberg electrode having a segmented structure is used, it is advantageous if the effective length of the waveguide is changed corresponding to a build-up of the electrode at the end cross-section with electrode particles for replacing consumed electrode mass in the consumable cross-section.

Independent of whether the propagation of the radar waves takes place in a waveguide disposed within the electrode mass or in a waveguide duct whose duct walls are formed by the electrode mass, it has proven advantageous if a rinsing agent is applied to the waveguide during operation of the electric furnace so as to prevent material from infiltrating the waveguide and forming undesired discontinuity points within the waveguide. It has proven particularly advantageous for forming a stream in the waveguide directed towards the consumable cross section if a rinsing gas is applied to the waveguide.

The apparatus according to the invention has a radar transmitter/receiver device, a waveguide tube arranged on the electrode and a waveguide connection device for connecting the waveguide tube to the radar transmitter/receiver device, wherein the waveguide tube extends from an end cross-section of the electrode in the consumption direction of the electrode to a consumable cross-section of the electrode.

In a preferred embodiment, the waveguide connection device has a changeable length for producing a waveguide connection between a radar transmitter/receiver device positioned independently of the electrode and the end cross-section of the electrode.

In particular for the use of the device on a Söderberg electrode, it is advantageous if, between the waveguide connection device and the waveguide tube, a waveguide connection is formed, in which an upper axial end of the waveguide tube is disposed axially slidable in relation to the lower axial end of the waveguide connection device in order to be able to perform adjustments to the position of the upper axial end of the electrode which changes as a result of the electrode structuring.

It is particularly advantageous if, for realizing the axial mobility, the waveguide connection is formed as a sliding sleeve, such that one end of the waveguide connection device and one and of the waveguide tube are arranged engaging each other. By this, it is possible to achieve a changeable length, which influences the propagation characteristics of the radar waves between the consumable cross-section of the electrode and the radar transmitter/receiver device as little as possible.

In order to provide a uniformly realized propagation of the radar waves in the waveguide independently of discontinuities in the structure of the electrode mass or to create reproducible conditions for the transfer of the electromagnetic waves in the electrode, it is advantageous if the waveguide is formed by a waveguide tube preferably running through the electrode mass.

In particular in the case if the measurement is to be performed on a Söderberg electrode, it is advantageous if the waveguide tube is composed of waveguide segments, which are connected to each other by at least one segment connector. The individual waveguide segments can be chosen in their length such that one waveguide segment is associated with one electrode piece of a Söderberg electrode, respectively.

In the case that the waveguide tube is composed of waveguide segments, it is advantageous if the segment connector has a cross-section adapter for forming a continuous inner diameter in a transition area between two waveguide segments in order to avoid discontinuities in the geometry of the waveguide tube influencing the propagation of the radar waves.

It is particularly advantageous if the waveguide tube has a tube material substantially containing graphite, which is not only well suited for the propagation of the radar waves, but also has a particularly high temperature stability and temperature resistance.

In particular for influencing the density or conductivity, the tube material can have a metallic or mineral content besides graphite.

If the waveguide tube is provided with an impregnation or coating, it is possible to prevent the electrode material molten during the electrode combustion from infiltrating the waveguide tube and, thus, counteract an impairment of the waveguide properties.

In the following, a preferred variation of the method will be explained further by illustrating a preferred embodiment of an employed apparatus with reference to the drawings.

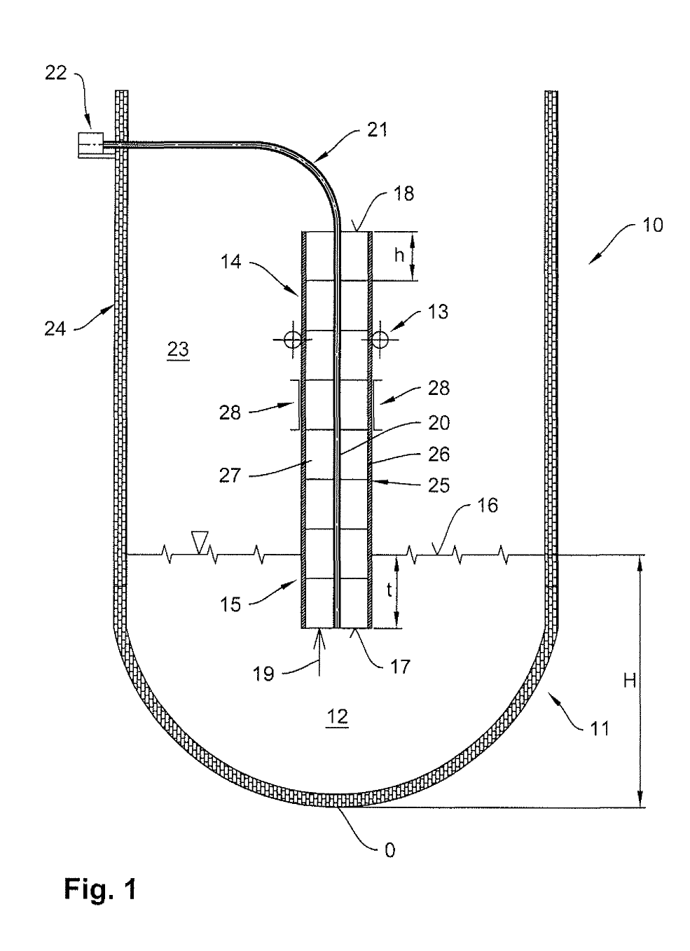

FIG. 1 shows an electric furnace with a Söderberg electrode in a schematic illustration;

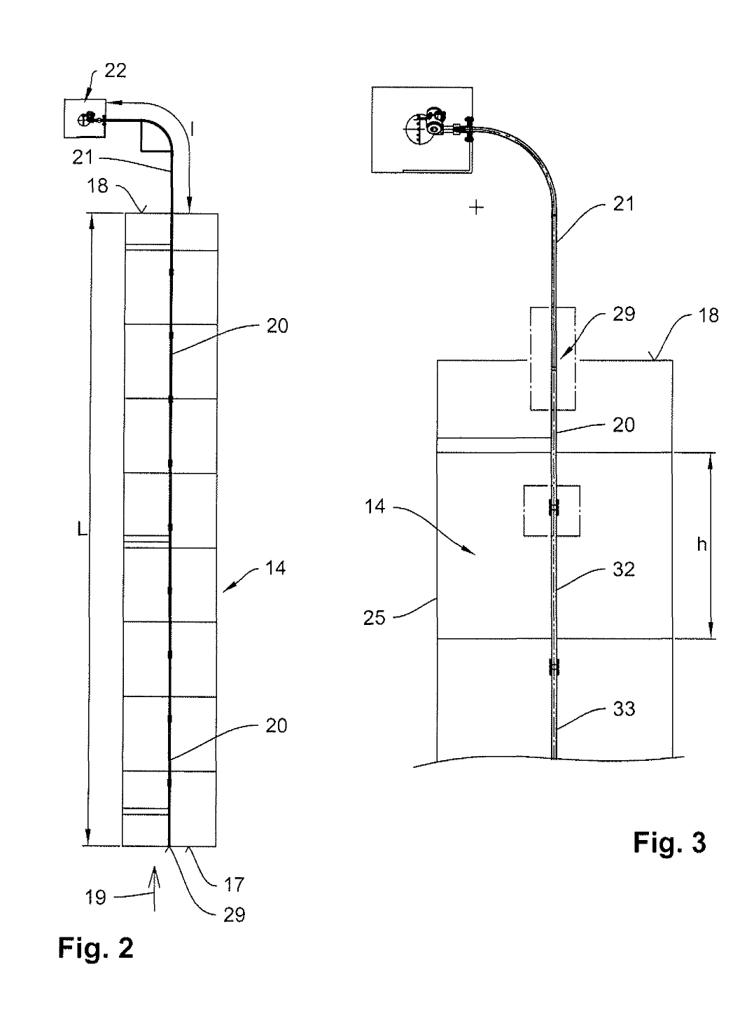

FIG. 2 shows an enlarged illustration of the Söderberg electrode with a connected length measuring device;

FIG. 3 shows an enlarged partial view of the Söderberg electrode illustrated in FIG. 2 with a waveguide connection device on the end cross-section of the electrode and segment connectors arranged between the waveguide segments;

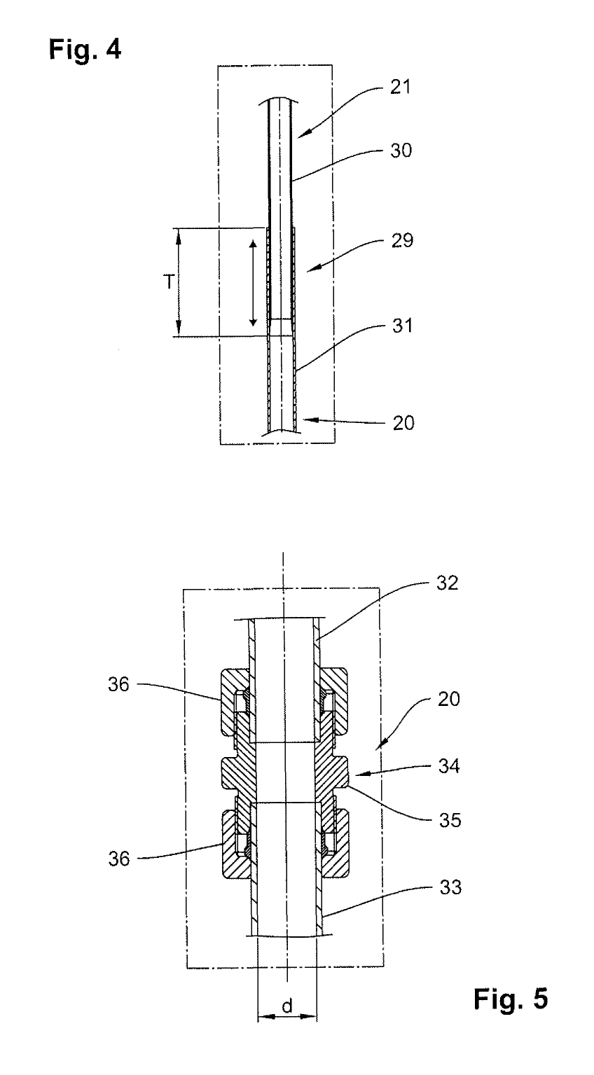

FIG. 4 shows an enlarged illustration of a piece of the waveguide connection device;

FIG. 5 shows an enlarged illustration of a segment connector.

FIG. 1 shows an electric furnace 10 with a furnace vessel 11, which holds a molten bath 12 of molten metal. Above the molten bath 12, an electrode 14, here realized as a Söderberg electrode, is disposed in an electrode feeding device 13, the lower consumable end 15 of which electrode is dipped into the molten bath 12, such that; between a bath surface 16 and a consumable cross-section 17 forming the lower frontal cross-section of the electrode; a melt distance t from the melt surface (bath surface 16) is formed, which surface is disposed at a height H above a furnace reference point O. In the case of the here illustrated realization example, the electrode 14 has an end cross-section 18 above the electrode feeding device 13.

Between the end cross-section 18 and the consumable cross-section 17, a waveguide tube 20 extends in the direction (consumption direction 19) of the continuous consumption of the electrode 14 resulting from the electrode combustion. To said waveguide tube 20, by means of a waveguide connection device 21, a radar transmitter/receiver device 22 is connected, which in the present case is stationary fastened outside of the furnace chamber 23 of the electric furnace 10 to an outer wall 24 of the electric furnace 10.

The electrode 14, formed in this case as a Söderberg electrode, is composed of a plurality of electrode pieces 25, which each have a steel ring 26 holding a carbon paste 27 within, said carbon ring 27 defining the outer shape. The electrode 14 is composed in situ from the pieces 25 during operation of the electric furnace 10, such that new pieces 25 are set onto the respective end cross-section 18 of the top piece 25 at the same rate at which a consumption of pieces 25 takes place on the consumable end 15 of the electrode 14. Since, corresponding to the electrode combustion on the consumable end 15 of the electrode 14, a feeding of the electrode 14 against the consumption direction 19 takes place, the position of the end cross-section 18 changes substantially in an area corresponding to the height h of a piece 25 so that the end cross-section 18 moves by about the measure h upwards and downwards.

In the process of feeding the electrode 14, pieces 25 which have been newly placed on the end cross-section 18 come into the area of pole shoes 28, through which electricity is routed into the electrode 14, which causes a baking of the carbon paste 27 and is used for generating a not illustrated electric arc on the consumable cross-section 17 of the electrode 14, which leads to a consumption of the electrode 14.

In FIGS. 2 and 3, the electrode 14 is illustrated with the radar transmitter/receiver device 22 connected to it. As it can be taken from FIG. 2, a value measured with the radar measurement of the stationary, i.e. independently from the electrode 14, arranged radar transmitter/receiver device 22 corresponds to the relative position of the consumable cross-section 17 to the radar transmitter/receiver device 22 under the condition that a waveguide end 29 of the waveguide tube 20 is positioned in the plane of the consumable cross-section 17. If the length 1 of the waveguide connection device 21 is known, the length L of the electrode or the position of the consumable cross-section 17 can be immediately determined. If the position of the consumable cross-section 17 is known, the melt distance t can be determined in the simplest way under consideration of the known position of the melt surface (bath surface 16)(see also FIG. 1).

FIG. 4 shows the transition between the waveguide connection device 21 illustrated in FIG. 3 and the waveguide tube 20 in the area of the end cross-section 18 in an enlarged illustration. As FIG. 4 shows, a waveguide connection 29 between the waveguide connection device 21 and the waveguide tube 20 is realized in such a manner that a free end 30 of the waveguide connection device 21 is telescopically inserted into a neighboring free end 31 of the waveguide tube and in doing so the waveguide connection 29 is realized as a sliding sleeve.

Due to the telescope length T1 of the waveguide connection device 21 made possible with the sliding sleeve 29, the distance of the radar transmitter/receiver device 22 to the end cross-section 18 can be changed by the telescope length T. This means, if the telescope length T about corresponds to the height h of a piece 25 of the electrode 14, a waveguide contact between the radar transmitter/receiver device 22 and the end 31 of the waveguide tube 20 in the end cross-section 18 of the electrode 14 can be maintained despite a stationary arrangement of the radar transmitter/receiver device 22.

FIG. 5 shows a segment connector 34, arranged respectively, as illustrated in FIG. 3, between two waveguide segments 32, 33 of the waveguide tube 20 for the continuous connection of the waveguide segments 32, 33. As FIG. 5 shows in detail, the segment connector 34 substantially comprises a cross-section adapter 35, which has an inner diameter d matching the waveguide segments 32, 33. The connection of the cross-section adapter 35 to the waveguide segment 32, 33 is respectively accomplished via a tube screw connection 36.

1. A method for measuring the length of an electrode or determining the position of a consumable cross-section of the electrode in an electric furnace, in which the measuring is performed by radar, said method comprising:
connecting a radar transmitter/receiver device to a waveguide using a waveguide connection device, said waveguide being arranged on the electrode and extending in a consumption direction of the electrode from an end cross-section of the electrode to a consumable cross section of the electrode;
emitting a radar signal;
receiving an echo of the radar signal produced by a reflection from a discontinuity point of the waveguide in the consumable cross section of the electrode; and
measuring a time difference between the emission of the radar signal and reception of the echo produced by the reflection from the discontinuity point of the waveguide in the consumable cross section of the electrode.

2. The method according to claim 1, including changing a length of the waveguide connection device to adjust a spatial distance between the radar transmitter/receiver device, positioned independently of the electrode, and the end cross-section of the electrode.

3. The method according to claim 1, including changing an effective length of the waveguide corresponding to a build-up of the electrode with electrode pieces taking place on the end cross-section for replacing electrode mass consumed in the consumable cross-section.

4. The method according to claim 1, including during operation of the electric furnace, subjecting the waveguide to a through-flow of a rinsing agent in a direction oriented towards the consumable cross-section.

5. An apparatus for measuring the length of an electrode or determining the position of the electrode in an electric furnace, said apparatus comprising:
a radar transmitter/receiver device;
a waveguide tube arranged on the electrode; and
a waveguide connection device connecting the radar transmitter/receiver device to an end of the waveguide tube on an end cross-section of the electrode, wherein the waveguide tube extends from the end cross-section of the electrode in a consumption direction of the electrode to a consumable cross-section of the electrode.

6. The apparatus according to claim 5, in which the waveguide connection device has an adjustable length connecting the radar transmitter/receiver device positioned independently of the electrode to the end cross-section of the electrode.

7. The apparatus according to claim 5, in which a waveguide connection is formed between the waveguide connection device and the waveguide, wherein an upper axial end of the waveguide is disposed axially slidable in relation to the lower axial end of the waveguide connection device.

8. The apparatus according to claim 7, in which the waveguide connection is sliding sleeve, such that an end of the waveguide connection device and an end of the waveguide tube are disposed engaging each other.

9. The apparatus according to claim 5, in which the waveguide tube is composed of waveguide segments connected to each other by at least one segment connector.

10. The apparatus according to claim 9, in which the segment connector has a cross-section adapter for forming a continuous inner diameter d in a transition area between two waveguide segments.

11. The apparatus according to claim 5, in which the waveguide tube has a tube material substantially containing graphite.

12. The apparatus according to claim 11, in which apart from graphite, the tube material contains a metallic content as a substantial component.

13. The apparatus according to claim 11, in which apart from graphite, the tube material contains a mineral content as a substantial component.

14. The apparatus according to claim 5, in which the waveguide tube is provided with an impregnation.

15. The apparatus according to claim 5, in which the waveguide tube is provided with a coating. The method according to claim 1, in which the waveguide is at least one of a waveguide tube and waveguide duct.
